(19) United States
(12) Patent Application Publication
(10) Pub. No.: US 2016/0275338 A1
(43) Pub. Date: Sep. 22, 2016

(54) IMAGE PROCESSING APPARATUS, IMAGE PROCESSING METHOD, AND COMPUTER-READABLE STORING MEDIUM

(71) Applicant: CASIO COMPUTER CO., LTD., Tokyo (JP)

(72) Inventor: Tetsuji MAKINO, Tokyo (JP)

(73) Assignee: CASIO COMPUTER CO., LTD., Tokyo (JP)

(21) Appl. No.: 15/014,910

(22) Filed: Feb. 3, 2016

(30) Foreign Application Priority Data
Mar. 18, 2015 (JP) 2015-054400

(51) Int. Cl. G06K 9/00; G06T 13/40; G06T 3/00; G06T 7/00; G06T 7/40

(52) U.S. Cl. CPC G06K 9/00281; G06T 7/0085; G06T 7/408; G06T 3/0056; G06T 13/40; G06T 2207/10024; G06T 2207/30201; G06T 2207/20121

(57) ABSTRACT

An image processing apparatus includes at least one processor configured to determine whether a mouth in an image of a human face is open or not, on the basis of image information on a central area of the mouth in the face image and image information on a peripheral area of the central area of the mouth in the face image, and correct the image information on the central area of the mouth in the face image in the case where the mouth is open.

### BACKGROUND OF THE INVENTION

1. Field of the Invention

The present invention relates to an image processing apparatus, an image processing method, and a computer-readable storing medium.

2. Description of the Related Art

A technique of determining an image in which a mouth of a person is not half-open as a representative image of moving-image content is conventionally known (see, for example, Japanese Patent Application Laid-Open No. 2012-004722).

In the case where a mouth part is detected from a photographed image (still image) in which the mouth of a person is half-open, as shown in FIG. 10, a mouth part including teeth, as indicated by the dotted line in FIG. 11, is detected. In face transformation processing of opening and closing the mouth in accordance with speech, such a mouth part including the teeth is considered to be the closed state of the mouth, and the processing is performed to insert teeth into an opening that appears when the mouth is opened. This leads to formation of an image which includes an unnatural-looking mouth with teeth inserted inside the teeth, as shown in FIG. 12.

An object of the present invention is to make it possible to provide an image in which a mouth is prevented from being drawn unnaturally.

### SUMMARY OF THE INVENTION

To achieve the above object, an image processing apparatus as recited in claim 1 of the present invention includes at least one processor configured to determine whether a mouth in an image of a human face is open or not, on the basis of image information on a central area of the mouth in the face image and image information on a peripheral area of the central area of the mouth in the face image, and correct the image information on the central area of the mouth in the face image in the case where the mouth is open.

### BRIEF DESCRIPTION OF THE SEVERAL VIEWS OF THE DRAWING

FIG. 1 shows, by way of example, an overall configuration of an image output system according to an embodiment of the present invention;

FIG. 2 is a block diagram showing the functional configuration of the image processing apparatus in FIG. 1;

FIG. 3 is a block diagram showing the functional configuration of the digital signage device in FIG. 1;

FIG. 4 shows a schematic configuration of the screen unit in FIG. 3;

FIG. 5 is a flowchart illustrating moving-image data generating processing which is carried out by the control unit in FIG. 2;

FIG. 6 illustrates a region's peripheral area and a region's central area;

FIG. 7 schematically shows color maps obtained by plotting color information on pixels in a lip region and color information on pixels in a teeth region within a mouth part region onto the HSV coordinate system;

FIG. 8 illustrates an inner boundary of the lips in the mouth part region;

FIG. 9 illustrates a mouth opening amount;

FIG. 10 illustrates a picked-up image in which the mouth is half-open, in a conventional technique;

FIG. 11 illustrates processing of opening and closing the mouth using the picked-up image including the half-open mouth, in the conventional technique; and

FIG. 12 illustrates the result of processing when the picked-up image including the half-open mouth is used to perform face transformation processing of opening and closing the mouth, in the conventional technique.

### DETAILED DESCRIPTION OF THE INVENTION

A suitable embodiment according to the present invention will be described below in detail with reference to the accompanying drawings. It should be noted that the present invention is not limited to the illustrated case.

[Configuration of Image Output System 100]

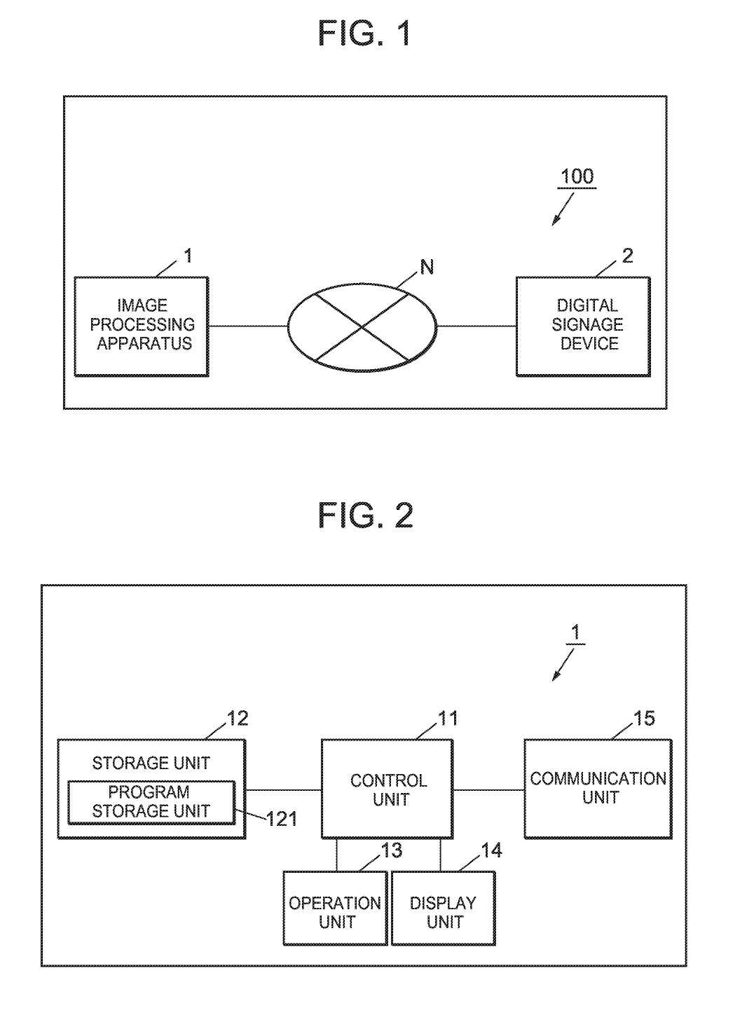

FIG. 1 shows an overall configuration of an image output system 100 according to an embodiment of the present invention. The image output system 100 includes an image processing apparatus 1 and a digital signage device 2 which are connected so as to be able to transmit and receive data to and from each other via a communication network N such as a local area network (LAN), a wide area network (WAN), the Internet, or the like.

[Configuration of Image Processing Apparatus 1]

FIG. 2 is a block diagram showing the major control configuration of the image processing apparatus 1. The image processing apparatus 1 is an apparatus which generates moving-image data on the basis of a single face image and transmits the generated moving-image data to the digital signage device 2. For example, a personal computer (PC) or the like is applicable as the apparatus. The image processing apparatus 1 includes a control unit 11, a storage unit 12, an operation unit 13, a display unit 14, and a communication unit 15, as shown in FIG. 2.

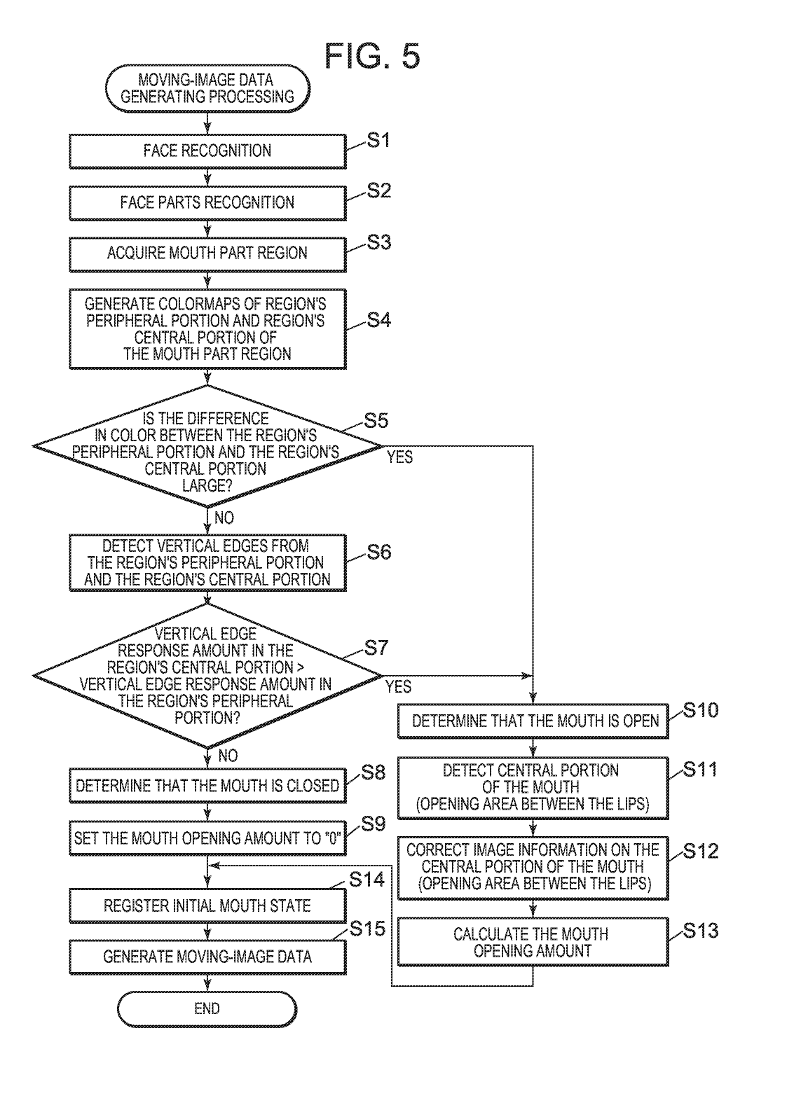

The control unit 11 includes a central processing unit (CPU), which executes various programs stored in a program storage unit 121 in the storage unit 12 to perform prescribed computations and control various components and elements, and a memory used as a work area during execution of the programs. The CPU and the memory are not shown in the figure. The control unit 11 works in cooperation with the programs stored in the program storage unit 121 in the storage unit 12, to carry out moving-image data generating processing, shown in FIG. 5, and transmit the generated moving-image data to the digital signage device 2. The control unit 11 functions as a recognition section, detection section, correction section, determination section, generation section, edge detecting section, calculating section, and moving-image data generating section. These sections may be configured with a single processor, or a plurality of processors may be provided for the respective sections to perform the corresponding operations.

The storage unit 12 is configured with a hard disk drive (HDD), a non-volatile semiconductor memory, or the like. The storage unit 12 includes the program storage unit 121, as shown in FIG. 2. The program storage unit 121 stores a system program executed in the control unit 11, processing programs for executing various kinds of processing including the moving-image data generating processing which will be described later, and data required for executing these programs.

The storage unit 12 also stores a photographed image (still image; in the present embodiment, two-dimensional image) used as a source image of moving-image data, and sound data for the moving-image data. It should be noted that the sound data may be text data representing the sound (speech).

The operation unit 13 includes a key board having a cursor key, character input keys, numeric keys, and various function keys, and a pointing device such as a mouse. The operation unit 13 outputs instruction signals, input by the key operations on the keyboard or the mouse operation, to the control unit 11. The operation unit 13 may include a touch panel on a display screen of the display unit 14. In this case, the operation unit 13 also outputs instruction signals, input via the touch panel, to the control unit 11.

The display unit 14 is configured with a liquid crystal display (LCD), cathode ray tube (CRT), or other monitor. The display unit 14 displays various kinds of screens in accordance with instructions by display signals received from the control unit 11.

The communication unit 15 includes a modem, router, network card, and the like, and performs communication with external equipment connected to the communication network N.

[Configuration of Digital Signage Device 2]

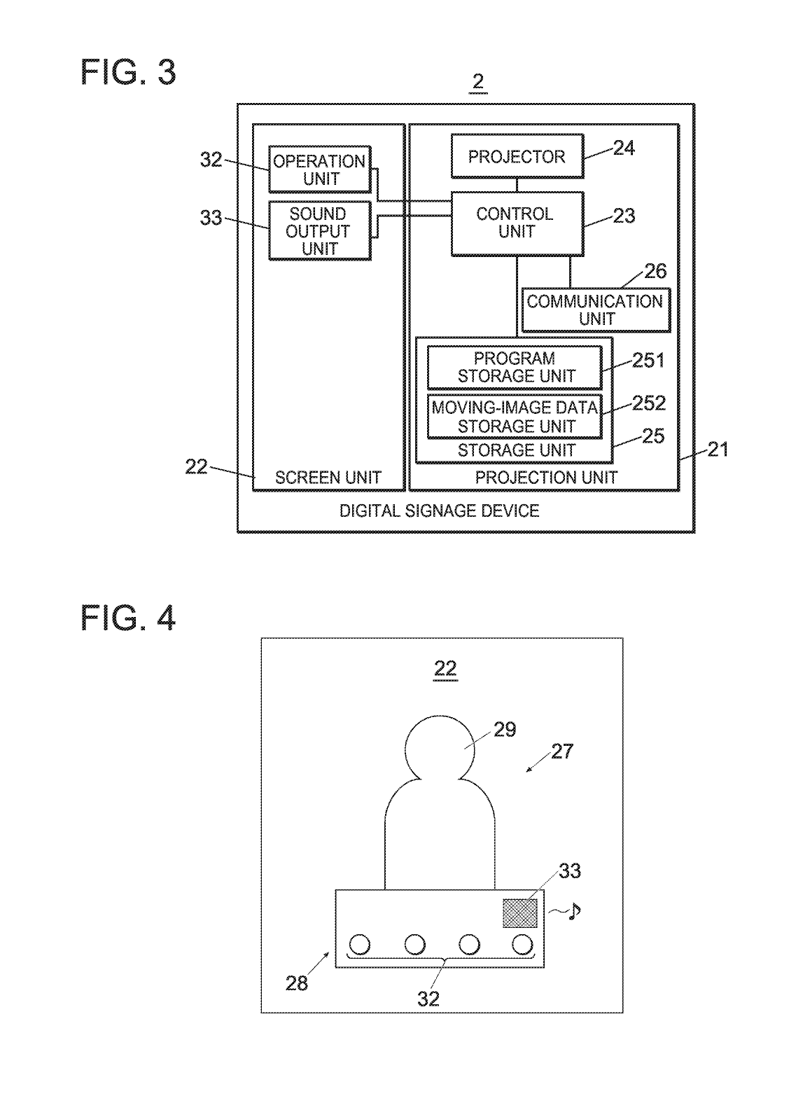

FIG. 3 is a block diagram showing the major control configuration of the digital signage device 2. The digital signage device 2 is a device which outputs moving-image content on the basis of the moving-image data generated in the image processing apparatus 1.

As shown in FIG. 3, the digital signage device 2 includes a projection unit 21 which emits video light, and a screen unit 22 which receives the video light emitted from the projection unit 21 on a rear face and projects the video light on a front face.

First, the projection unit 21 will be described.

The projection unit 21 includes a control unit 23, a projector 24, a storage unit 25, and a communication unit 26. The projector 24, the storage unit 25, and the communication unit 26 are connected to the control unit 23, as shown in FIG. 3.

The control unit 23 includes a CPU, which executes various programs stored in a program storage unit 251 in the storage unit 25 to perform prescribed computations and control various components and elements, and a memory used as a work area during execution of the programs. The CPU and the memory are not shown in the figure.

The projector 24 is a projection device which converts image data output from the control unit 23 into video light, and emits the resultant light toward the screen unit 22. As the projector 24, a DLP (registered trademark) (digital light processing) projector, for example, is applicable. The DLP projector utilizes a digital micromirror device (DMD) which is a display element in which a plurality of small mirrors are arranged in an array (horizontally 1024 pixels and vertically 768 pixels in the case of XGA), and the tilt angles of the individual mirrors are rapidly switched between the on and off states, to thereby form an optical image by the light reflected therefrom.

The storage unit 25 is configured with a hard disk drive (HDD), a non-volatile semiconductor memory, or the like. The storage unit 25 includes the program storage unit 251, as shown in FIG. 3. The program storage unit 251 stores a system program executed in the control unit 23, various kinds of processing programs, and data required for executing these programs.

The storage unit 25 further includes a moving-image data storage unit 252 which stores moving-image data transmitted from the image processing apparatus 1. The moving-image data is configured with a plurality of frame images and sound data corresponding to the respective frame images.

The screen unit 22 will now be described.

FIG. 4 is a front view showing the schematic configuration of the screen unit 22. As shown in FIG. 4, the screen unit 22 includes an image forming unit 27, and a base unit 28 which supports the image forming unit 27.

The image forming unit 27 is a screen which has a light-transmitting plate 29 of an acrylic plate, for example, formed into a human shape and arranged in a direction approximately orthogonal to the video light emitting direction, and also has a film screen for rear projection, having a film-type Fresnel lens laminated, adhered to the plate 29. This image forming unit 27 and the projector 24 described above constitute an output section.

The base unit 28 includes a button-type operation unit 32, and a sound output unit 33, such as a speaker, for outputting sound.

The operation unit 32 includes various operation buttons, and detects and outputs an operation button depression signal to the control unit 23.

The operation unit 32 and the sound output unit 33 are connected to the control unit 23, as shown in FIG. 3.

[Operation of Image Output System 100]

An operation of the image output system 100 will now be described.

As described above, the image output system 100 includes the image processing apparatus 1, which generates moving-image data on the basis of a photographed image and sound data, and the digital signage device 2, which outputs moving-image content on the basis of the generated moving-image data.

FIG. 5 is a flowchart illustrating moving-image data generating processing which is carried out in the image processing apparatus 1. The moving-image data generating processing is carried out, by the cooperation of the control unit 11 and the program stored in the program storage unit 121, when a photographed image of a person and sound data as a source of generation of moving-image data are selected from among the photographed images and sound data stored in the storage unit 12 and generation of moving-image data is instructed via the operation unit 13. Although the photographed image of a person is not particularly limited, it is here explained as an image of an RGB color system. Further, image information on each pixel in a photographed image includes color information and an alpha channel value (transmittance value).

First, the control unit 11 performs face recognition processing on a photographed image selected (step S1). The technique of face recognition processing is not particularly limited; any known image processing technology such as the technique using the Haar-like features, as described in Japanese Patent Application Laid-Open No. 2012-053813, for example, can be adopted.

Next, the control unit 11 performs face parts recognition processing on the region of the face recognized in step S1 (step S2), and acquires a region of the mouth part recognized by the face parts recognition processing (step S3). The face parts recognition processing can be performed using a known image processing technology such as the Active Appearance Models (AAM), for example.

Next, the control unit 11 generates color maps of a region's peripheral area and a region's central area within the mouth part region (step S4).

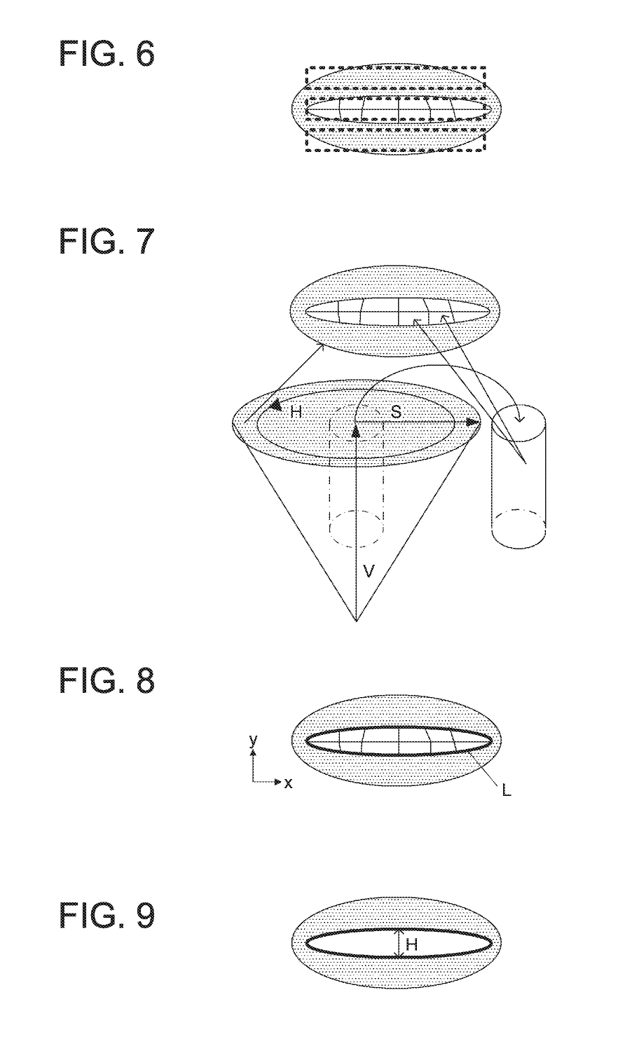

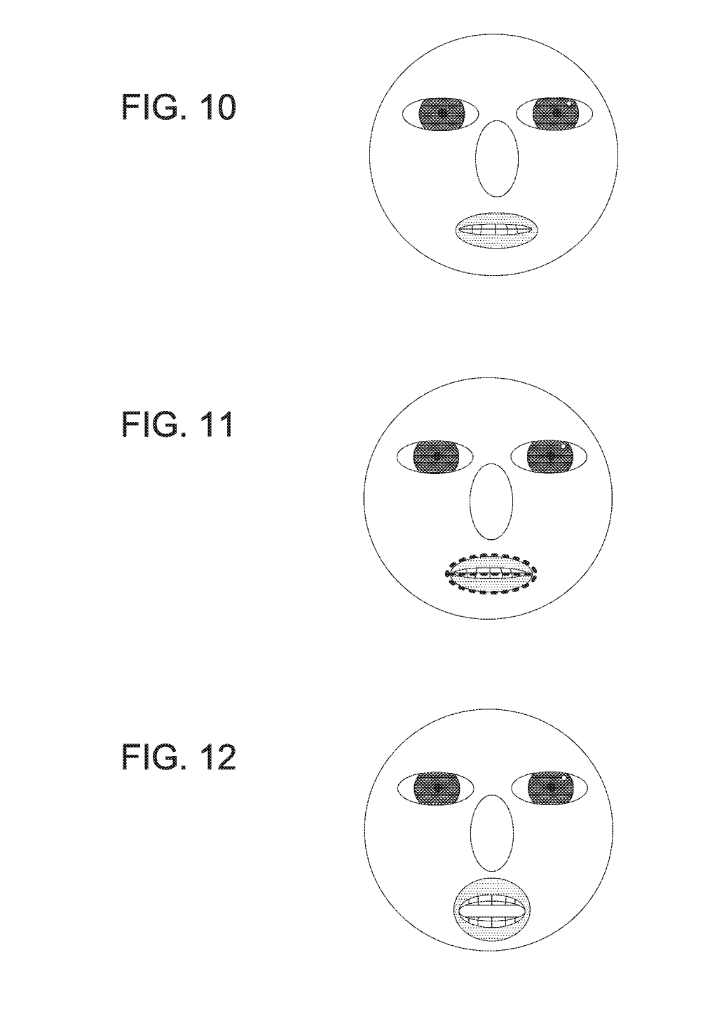

In step S4, for example, color information on the region's peripheral area and color information on the region's central area within the mouth part region in the photographed image are converted into the HSV color system, and they are plotted onto the HSV coordinate system. For example in the case where the mouth part region is divided into three regions of upper, middle, and lower regions (see the dotted lines in FIG. 6), the region's peripheral area corresponds to prescribed ranges in the upper and lower regions, and the region's central area corresponds to a prescribed range in the middle region.

Here, FIG. 7 schematically shows color maps obtained by plotting color information on pixels in the lip region and color information on pixels in the teeth region within the mouth part region, onto the HSV coordinate system. As shown in FIG. 7, the color map of the lip region is distributed over the area where the lightness value (V) is relatively high (area with dot pattern in FIG. 7). On the other hand, the teeth are white and shadows of the lips may fall on the teeth, so the color map of the teeth region is distributed over the area where the saturation (S) is low and the area where the lightness value (V) ranges widely. That is, the color map of the teeth region is distributed in the cylindrical area near the achromatic axis (axis of the cone), indicated by the dot-dash line in FIG. 7.

When the mouth is closed, the mouth part region entirely corresponds to the lip region. Therefore, the color map of the region's peripheral area and the color map of the region's central area both become like the area with the dot pattern in FIG. 7, in which case there is almost no difference between the two areas. On the other hand, when the mouth is open, the color map of the region's peripheral area becomes like the area with the dot pattern in FIG. 7, while the color map of the region's central area becomes like the cylindrical area indicated by the dot-dash line in FIG. 7, in which case there is a big difference therebetween.

While the case of generating a color map using the HSV color system, which is capable of readily expressing the effects of the shadows of the lips falling on the teeth, has been described in the above example, another color system may be used as well.

Next, the control unit 11 calculates a difference in color between the region's peripheral area and the region's central area within the mouth part region, on the basis of the generated color maps, and determines whether the calculated difference is larger than a predetermined threshold value (step S5). For example, an average of the color information on the pixels within the region's peripheral area and an average of the color information on the pixels within the region's central area are obtained, and it is determined whether the distance between them on the HSV coordinate system is larger than a predetermined threshold value.

If the difference in color between the region's peripheral area and the region's central area within the mouth part region is not larger than the predetermined threshold value (NO in step S5), or, if the color difference between the region's peripheral area and the region's central area within the mouth part region is insufficient to determine that the mouth is open, then the control unit 11 detects vertical edges in the region's peripheral area and in the region's central area, to thereby calculate their vertical edge response amounts (step S6).

For example, a Sobel filter for detecting vertical lines is used to detect vertical edges (edges extending in the vertical direction) in the region's peripheral area (upper region and lower region) within the mouth part region in the photographed image, and an average of the absolute values of the response values of the respective pixels obtained, for example, is calculated as the vertical edge response amount of the region's peripheral area. Similarly, a Sobel filter for detecting vertical lines is used to detect vertical edges in the region's central area within the mouth part region in the photographed image, and an average of the absolute values of the response values of the respective pixels obtained is calculated as the vertical edge response amount of the region's central area.

While the case of dividing the mouth part region evenly into three areas and allocating them to the upper and lower regions of the region's peripheral area and to the region's central area has been illustrated in FIG. 6, the way of dividing the mouth part region is not limited thereto; the sizes of the respective areas may be adjusted as appropriate in accordance with the size of the mouth part region or the like, for calculating the response amounts of those areas. Alternatively, a face image may be displayed on the display unit 14 and the region's peripheral area and the region's central area may be determined in accordance with the user operation of the operation unit 13. The region's peripheral area and the region's central area may be different from those used when creating the color maps. Further, the method of calculating the vertical edge response amounts is not limited to the method using the Sobel filters; Hough transformation, for example, or other technique may be adopted.

Next, the control unit 11 compares the vertical edge response amount of the region's peripheral area with the vertical edge response amount of the region's central area to determine whether the vertical edge response amount of the region's central area is larger than the vertical edge response amount of the region's peripheral area (step S7).

Here, when the mouth is open, as shown in FIG. 6, clear vertical edges between teeth are detected within the region's central area, resulting in a large vertical edge response amount. On the other hand, the region's peripheral area corresponds to the lip region, where only weak vertical edges corresponding to the wrinkles are detected, resulting in a small vertical edge response amount. That is, in the case where the mouth is open, the vertical edge response amount of the region's central area is larger than the vertical edge response amount of the region's peripheral area. On the other hand, when the mouth is closed, the region's central area includes no teeth but the lips, so there is almost no difference between the vertical edge response amount of the region's central area and that of the region's peripheral area.

If it is determined in step S7 that the vertical edge response amount of the region's central area is not larger than the vertical edge response amount of the region's peripheral area (NO in step S7), the control unit 11 determines that the mouth is closed (step S8), and determines the mouth opening amount as zero (step S9). The process then proceeds to step S14.

On the other hand, if it is determined in step S5 that the difference in color between the region's peripheral area and the region's central area within the mouth part region is larger than the predetermined threshold value (YES in step S5), or if it is determined in step S7 that the vertical edge response amount of the region's central area is larger than the vertical edge response amount of the region's peripheral area (YES in step S7), then the control unit 11 determines that the mouth is open (step S10). The control unit 11 then acquires the inner boundary (L in FIG. 8) of the lips in the mouth part region, and detects the region inside the boundary as a central area of the mouth in the human face (opening area between the lips) (step S11).

A description will be made about the case, for example, where it is determined in step S5 that the difference in color between the region's peripheral area and the region's central area is large. In this case, the HSV color space obtained by plotting the color maps of the region's peripheral area and the region's central area is separated using a known separation technique such as the least squares method, to obtain the color boundary between the region's peripheral area and the region's central area in the HSV color space. The inner boundary of the lips (L in FIG. 8) in the mouth part region is then acquired on the basis of the color boundary obtained. A description will also be made about the case, for example, where it is determined in step S5 that the difference in color between the region's peripheral area and the region's central area is small. In this case, horizontal edges (edges extending in the horizontal direction) in the mouth part region are detected using a Sobel filter for detecting horizontal lines. For the edge image obtained by the detection, a response value profile in the y direction is created for each x coordinate, and the inner boundary of the lips in the mouth part region is acquired on the basis of the peak of the response value.

Next, the control unit 11 corrects the image information on the detected region of the central area of the mouth in the human face (opening area between the lips) (step S12). For example, the alpha channel value (transmittance value) included in the image information on the region of the central area of the mouth (opening area between the lips) in the photographed image is corrected to zero, such that no color will be drawn therein. Alternatively, the color information on the region of the central area of the mouth (opening area between the lips) in the photographed image may be corrected to a predetermined value, such as zero, a maximum value, or a value close to that of the lip color.

The control unit 11 then calculates the mouth opening amount (step S13), and the process proceeds to step S14. In step S13, for example, a longest distance H in the vertical direction (up-and-down direction) of the region of the central area of the mouth (opening area between the lips), as shown in FIG. 9, is calculated as the mouth opening amount.

In step S14, the control unit 11 registers an initial image and the mouth opening amount as an initial mouth state. When it is determined that the mouth is closed, the original image is registered as the initial image. When it is determined that the mouth is open, a photographed image in which the central area of the mouth (opening area between the lips) has been corrected is registered as the initial image. Then, on the basis of the registered initial image and the registered mouth opening amount, the control unit 11 performs face transformation processing of opening and closing the mouth and other parts in accordance with the sound data, to generate moving-image data (step S15). The moving-image data generating processing is then terminated. The face transformation processing can be performed using a known image processing technology.

Here, in the case of closing the mouth in the face transformation processing, generally, the image is returned to the initial image. In the present embodiment, the processing is performed to close the mouth in the initial image by the mouth opening amount. In the case of opening the mouth, the teeth and the inner wall of the oral cavity are drawn in the region of the central area of the mouth (opening area between the lips). In this case, even in the case where the mouth was open in the original image, in the initial image, the information on the teeth and the inner wall of the oral cavity within the region of the central area of the mouth (opening area between the lips) has been erased. This can prevent creation of unnatural-looking moving-image data in which teeth are inserted between the teeth.

When the moving-image data generating processing is complete, the control unit 11 transmits the generated moving-image data to the digital signage device 2 through the communication unit 15.

In the digital signage device 2, when the communication unit 26 receives the moving-image data from the image processing apparatus 1, the control unit 23 stores the received moving-image data into the moving-image data storage unit 252 in the storage unit 25. When the time to reproduce the moving-image content comes, the control unit 23 reads the moving-image data from the moving-image data storage unit 252, and transmits the image data to the projector 24 to cause the moving-image content to be displayed on the image forming unit 27. The control unit 23 also outputs the sound data of the moving-image data to the sound output unit 33, to cause the sound to be output.

As described above, according to the image processing apparatus 1, the control unit 11 recognizes a mouth from a photographed image of a person, detects a central area of the mouth (opening area between the lips) from the recognized mouth region, and corrects the image information on the detected central area of the mouth (opening area between the lips).

Accordingly, for example in the case of performing face transformation processing of opening and closing the mouth in accordance with speech, it is possible to provide an image in which the mouth is prevented from being drawn unnaturally.

For example, the transmittance value on each pixel within the region of the central area of the mouth (opening area between the lips) may be corrected to a value according to which no color will be drawn in the central area of the mouth (opening area between the lips), which makes it possible to provide the image in which the mouth is prevented from being drawn unnaturally when the face transformation processing of opening and closing the mouth in accordance with speech is performed. Alternatively, the color information included in the image information on the central area of the mouth (opening area between the lips) may be corrected to a predetermined value, such as zero, a maximum value, or a value close to that of the lip color, which makes it possible to provide the image in which the mouth is prevented from being drawn unnaturally when the face transformation processing of opening and closing the mouth in accordance with speech is performed.

Further, the control unit 11 determines whether the mouth recognized from the photographed image of a person is open or not and, when determining that the mouth is open, detects and corrects the central area of the mouth (opening area between the lips). This makes it possible to perform processing uniformly on any original image, without the need for a user to check whether the mouth in the original image is half-open or not.

In determining whether the mouth of a person in a photographed image is open or not, for example, color maps of the region's peripheral area and the region's central area within the region of the mouth recognized from the photographed image may be generated, and the determination may be made on the basis of the generated color maps. Alternatively, for example, vertical edges may be detected from the region of the mouth recognized from the photographed image, and the determination may be made on the basis of the detection results of the vertical edges in the region's peripheral area and the region's central area in the mouth region.

Further, the central area of the mouth (opening area between the lips) may be detected on the basis of the color maps of the region's peripheral area and the region's central area in the region of the mouth recognized from the photographed image. Alternatively, the central area of the mouth (opening area between the lips) may be detected on the basis of the results of edge detection in the region of the mouth recognized from the photographed image.

Further, the control unit 11 may perform face transformation processing on a photographed image in which the image information on the central area of the mouth (opening area between the lips) has been corrected, to generate moving-image data in which the mouth of the person is opened and closed. This makes it possible to provide moving-image data including a natural-looking mouth, instead of an unnatural-looking mouth with teeth inserted between the teeth. Further, the control unit 11 may calculate the opening amount of the central area of the mouth (opening area between the lips), and perform face transformation processing on the photographed image in which the image information on the central area of the mouth (opening area between the lips) has been corrected, to thereby generate moving-image data in which the mouth of the person is opened and closed, on the basis of the calculated mouth opening amount. This makes it possible to provide moving-image data including a more natural-looking mouth.

It should be noted that the description of the above embodiment is a suitable example of the image processing apparatus and the digital signage device of the present invention; the present invention is not limited thereto.

For example, in the above embodiment, the lip boundary was acquired from the mouth part region, and the inside of the lip boundary was detected as the central area of the mouth (opening area between the lips). Alternatively, the upper lip and the lower lip may be recognized by image processing, and the area between the recognized upper and lower lips may be detected as the central area of the mouth (opening area between the lips).

Further, in the above embodiment, the image obtained by correcting the image information on the central area of the mouth (opening area between the lips) was adopted as the initial image for use in face transformation processing for generating moving-image data. Alternatively, the image obtained by closing the mouth by performing transformation of closing the mouth on the basis of the calculated mouth opening amount may be adopted as the initial image.

In the above embodiment, whether the mouth is open or not was determined on the basis of the vertical edges in the mouth part region when it was not possible to determine whether the mouth is open or not on the basis of the color map of the mouth part region. Alternatively, whether the mouth is open or not may be determined on the basis of the vertical edges alone.

The other detailed configurations and detailed operations of the image processing apparatus and the digital signage device may be modified as appropriate within the range not departing from the gist of the invention.

The transmittance value includes, not only values, but also information which is drawn transmissive color in the central area of the mouth in the face image.

While several embodiments of the present invention have been described, the scope of the present invention is not limited to the embodiments described above; rather, it includes the scope as recited in the claims and equivalent thereof.

What is claimed is:

1. An image processing apparatus comprising:
a processor configured to:
determine whether a mouth in an image of a human face is open or not, on the basis of image information on a central area of the mouth in the face image and image information on a peripheral area of the central area of the mouth in the face image; and
correct the image information on the central area of the mouth in the face image in the case where the mouth is open.

2. The image processing apparatus according to claim 1, wherein
the image information on the central area of the mouth in the face image is color map information, and
the image information on the peripheral area of the central area of the mouth in the face image is color map information.

3. The image processing apparatus according to claim 1, wherein the processor determines whether the mouth is open or not, according to whether the image information on the central area of the mouth in the face image includes vertical edge information or not.

4. The image processing apparatus according to claim 1, wherein
the image information includes transmittance value, and
the processor corrects the transmittance value included in the image information on the central area of the mouth in the face image to a value which is drawn transmissive color in the central area of the mouth in the face image.

5. The image processing apparatus according to claim 3, wherein
the image information includes transmittance value, and
the processor corrects the transmittance value included in the image information on the central area of the mouth in the face image to a value which is drawn transmissive color in the central area of the mouth in the face image.

6. The image processing apparatus according to claim 1, wherein
the image information includes color information, and
the processor corrects the color information included in the image information on the central area of the mouth in the face image to a predetermined value.

7. The image processing apparatus according to claim 1, wherein the processor is further configured to perform transformation processing on an image obtained by correcting the image information on the central area of the mouth in the face image, to generate moving-image data in which the mouth in the face image is opened and closed.

8. The image processing apparatus according to claim 7, wherein
the processor calculates a mouth opening amount on the basis of the image information on the detected central area of the mouth in the face image, and
the processor performs the transformation processing on the image obtained by correcting the image information on the central area of the mouth in the face image, to generate the moving-image data in which the mouth in the face image is opened and closed, on the basis of the calculated mouth opening amount.

9. An image processing method comprising:
a mouth region detecting step of detecting a mouth region from an image of a person;
an opening area detecting step of detecting an opening area between lips from the mouth region detected in the mouth region detecting step; and
a correcting step of correcting image information on the opening area between the lips detected in the opening area detecting step.

10. A computer-readable storing medium storing therein a program including a series of instructions to cause a computer in an image processing apparatus to perform:
a mouth region detecting function of detecting a mouth region from an image of a person;
an opening area detecting function of detecting an opening area between lips from the mouth region detected by the mouth region detecting function; and
a correcting function of correcting image information on the opening area between the lips detected by the opening area detecting function.

11. An image processing apparatus comprising at least one processor configured to:
recognize a mouth from an image of a person;
detect a central area of the mouth from a region of the recognized mouth; and
correct image information on the detected central area of the mouth.

12. The image processing apparatus according to claim 11, wherein the processor
determines whether the mouth recognized is open or not, and
detects an opening area between lips in the case of determining that the mouth is open.

13. The image processing apparatus according to claim 12, wherein the processor
generates color maps of a region's peripheral area and a region's central area of the region of the recognized mouth, and
determines whether the recognized mouth is open or not, on the basis of the generated color maps of the region's peripheral area and the region's central area of the mouth region.

14. The image processing apparatus according to claim 12, wherein the processor
performs edge detection on the region of the recognized mouth, and
determines whether the recognized mouth is open or not, on the basis of the edge detection results in a region's peripheral area and a region's central area of the mouth region.

15. The image processing apparatus according to claim 13, wherein the processor
performs edge detection on the region of the recognized mouth, and
determines whether the recognized mouth is open or not, on the basis of the edge detection results in the region's peripheral area and the region's central area of the mouth region.

16. The image processing apparatus according to claim 14, wherein the processor determines whether the recognized mouth is open or not, on the basis of the detection results of vertical edges in the region's peripheral area and the region's central area of the mouth region.

17. The image processing apparatus according to claim 15, wherein the processor determines whether the recognized mouth is open or not, on the basis of the detection results of vertical edges in the region's peripheral area and the region's central area of the mouth region.

18. The image processing apparatus according to claim 13, wherein the processor detects the opening area between the lips on the basis of the generated color maps.

19. The image processing apparatus according to claim 14, wherein the processor detects the opening area between the lips on the basis of generated color maps.

20. The image processing apparatus according to claim 15, wherein the processor detects the opening area between the lips on the basis of the generated color maps.
